(19) United States
(12) Patent Application Publication
(10) Pub. No.: US 2025/0337339 A1
(43) Pub. Date: Oct. 30, 2025

(54) SWITCHING CONTROL CIRCUIT AND POWER SUPPLY CIRCUIT

(71) Applicant: FUJI ELECTRIC CO., LTD., Kawasaki-shi (JP)

(72) Inventors: Hiroaki MATSUMOTO, Matsumoto-city (JP); Kiminori TANAKA, Matsumoto-city (JP)

(73) Assignee: FUJI ELECTRIC CO., LTD., Kawasaki-shi (JP)

(21) Appl. No.: 19/089,925

(22) Filed: Mar. 25, 2025

(30) Foreign Application Priority Data
Apr. 24, 2024 (JP) 2024-070850

(51) Int. Cl. H02M 7/217; H02M 1/00; H02M 1/32; H02M 1/42

(52) U.S. Cl. CPC H02M 7/217; H02M 1/32; H02M 1/0058; H02M 1/4208

(57) ABSTRACT

A switching control circuit for a power supply circuit, including: a first driver circuit configured to turn on a first transistor of the power supply circuit after an inductor current therein reaches a first value, and turn off the first transistor in response to an ON period corresponding to an output voltage of the power supply circuit having elapsed; a second driver circuit configured to, when the ON period of the first transistor is shorter than a first time period, drive the first transistor in a first mode, which is a mode in which the first transistor is switched in a state where a second transistor of the power supply circuit is kept off, and when the ON period exceeds the first time period, drive the second transistor in a second mode, which is a mode in which the second transistor is switched complementarily to the first transistor.

### CROSS-REFERENCE TO RELATED APPLICATIONS

The present application claims priority pursuant to 35 U.S.C. § 119 from Japanese patent application number 2024-070850, filed on Apr. 24, 2024, the entire disclosure of which is hereby incorporated by reference herein.

### BACKGROUND

### Technical Field

The present disclosure relates to a switching control circuit and a power supply circuit.

### Description of the Related Art

A typical power factor correction circuit (hereinafter, referred to as power factor correction (PFC) circuit) that operates in a critical mode improves a power factor by shaping the waveform of the peak values of an inductor current flowing through an inductor into a waveform similar to that of a rectified voltage obtained by rectifying an alternating current (AC) voltage (for example, Japanese Patent Application Publication No. 2021-052578 and WO 2023/048074).

Incidentally, the PFC circuit operates in a (current) critical mode or a (current) continuous mode, with needed output power. The critical mode is used for comparatively low-power devices, and the continuous mode is used for the comparatively high-power devices. This proposition relates to the critical mode.

However, when the PFC circuit is operated in the critical mode, switching loss of a transistor and/or conduction loss of a diode may become an issue.

### SUMMARY

A first aspect of the present disclosure is a switching control circuit for a power supply circuit that generates an output voltage at a target level from an alternating current (AC) voltage inputted thereto, the power supply circuit including an inductor configured to receive a voltage corresponding to the AC voltage, a first transistor configured to control an inductor current flowing through the inductor, and a second transistor connected to the inductor and the first transistor, the switching control circuit being configured to control switching of the first and second transistors, the switching control circuit comprising: a first driver circuit configured to turn on the first transistor after the inductor current reaches a first predetermined value, and turn off the first transistor in response to an ON period corresponding to the output voltage having elapsed; a second driver circuit configured to, in response to the ON period of the first transistor being shorter than a fist time period, drive the first transistor in a first mode, the first mode being a mode in which the first transistor is switched in a state where the second transistor is kept off, and in response to the ON period of the first transistor exceeding the first time period, drive the second transistor in a second mode, the second mode being a mode in which the second transistor is switched complementarily to the first transistor.

A second aspect of the present disclosure is a switching control circuit for a power supply circuit that generates an output voltage at a target level from an alternating current (AC) voltage inputted thereto, the power supply circuit including an inductor configured to receive a voltage corresponding to the AC voltage, a first transistor configured to control an inductor current flowing through the inductor, and a second transistor connected to the inductor and the first transistor, the switching control circuit being configured to control switching of the first and second transistors, the switching control circuit comprising: a first driver circuit configured to turn on the first transistor after the inductor current reaches a first predetermined value, and turn off the first transistor in response to an ON period corresponding to the output voltage having elapsed; and a second driver circuit configured to drive the second transistor in a first synchronous rectification mode, in response to an instantaneous value of a full-wave rectified voltage dropping below a predetermined level corresponding to the output voltage, the full-wave rectified voltage being obtained by full-wave rectifying the AC voltage, and drive the second transistor in a second synchronous rectification mode, in response to the instantaneous value exceeding the predetermined level, wherein the first synchronous rectification mode is a mode in which the second transistor is switched complementarily to the first transistor, and the second synchronous rectification mode is a mode in which the second transistor is turned on after the first transistor is turned off, and the second transistor is turned off, in response to a predetermined time period having elapsed since the inductor current flows in a direction that is opposite to a direction in which the inductor current flows when the first transistor is on.

A third aspect of the present disclosure is a switching control circuit for a power supply circuit that generates an output voltage at a target level from an alternating current (AC) voltage inputted thereto, the power supply circuit including an inductor configured to receive a voltage corresponding to the AC voltage, a first transistor configured to control an inductor current flowing through the inductor, and a second transistor connected to the inductor and the first transistor, the switching control circuit being configured to control switching of the first and second transistors, the switching control circuit comprising: a first driver circuit configured to turn on the first transistor after the inductor current reaches a first predetermined value, and turn off the first transistor, in response to an ON period corresponding to the output voltage having elapsed; and a second driver circuit configured to turn on the second transistor after the first transistor is turned off, and turn off the second transistor, in response to a predetermined time period having elapsed since the inductor current flows in a direction that is opposite to a direction in which the inductor current flows when the first transistor is on, wherein the predetermined time period is calculated based on the ON period and a time period from when the first transistor is turned off until when the inductor current reaches the first predetermined value.

A fourth aspect of the present disclosure is a power supply circuit configured to generate an output voltage at a target level from an alternating current (AC) voltage inputted thereto, the power supply circuit comprising: an inductor configured to receive a voltage corresponding to the AC voltage; a first transistor configured to control an inductor current flowing through the inductor; a second transistor connected to the inductor and the first transistor; and a switching control circuit configured to control switching of the first and second transistors, the switching control circuit including: a first driver circuit configured to turn on the first transistor after the inductor current reaches a first predetermined value, and turn off the first transistor in response to an ON period corresponding to the output voltage having elapsed; and a second driver circuit configured to, in response to the ON period of the first transistor being shorter than a fist time period, drive the first transistor in a first mode, the first mode being a mode in which the first transistor is switched in a state where the second transistor is kept off, and in response to the ON period of the first transistor exceeding the first time period, drive the second transistor in a second mode, the second mode being a mode in which the second transistor is switched complementarily to the first transistor.

A fifth aspect of the present disclosure is a power supply circuit configured to generate an output voltage at a target level from an alternating current (AC) voltage inputted thereto, the power supply circuit comprising: an inductor configured to receive a voltage corresponding to the AC voltage; a first transistor configured to control an inductor current flowing through the inductor; a second transistor connected to the inductor and the first transistor; and a switching control circuit configured to control switching of the first and second transistors, the switching control circuit including: a first driver circuit configured to turn on the first transistor after the inductor current reaches a first predetermined value, and turn off the first transistor in response to an ON period corresponding to the output voltage having elapsed; and a second driver circuit configured to drive the second transistor in a first synchronous rectification mode, in response to an instantaneous value of a full-wave rectified voltage dropping below a predetermined level corresponding to the output voltage, the full-wave rectified voltage being obtained by full-wave rectifying the AC voltage, and drive the second transistor in a second synchronous rectification mode, in response to the instantaneous value exceeding the predetermined level, wherein the first synchronous rectification mode is a mode in which the second transistor is switched complementarily to the first transistor, and the second synchronous rectification mode is a mode in which the second transistor is turned on after the first transistor is turned off, and the second transistor is turned off, in response to a predetermined time period having elapsed since the inductor current flows in a direction that is opposite to a direction in which the inductor current flows when the first transistor is on.

A sixth aspect of the present disclosure is a power supply circuit configured to generate an output voltage at a target level from an alternating current (AC) voltage inputted thereto, the power supply circuit comprising: an inductor configured to receive a voltage corresponding to the AC voltage; a first transistor configured to control an inductor current flowing through the inductor; a second transistor connected to the inductor and the first transistor; and a switching control circuit configured to control switching of the first and second transistors, the switching control circuit including: a first driver circuit configured to turn on the first transistor after the inductor current reaches a first predetermined value, and turn off the first transistor in response to an ON period corresponding to the output voltage having elapsed; and a second driver circuit configured to turn on the second transistor after the first transistor is turned off, and turn off the second transistor, in response to a predetermined time period having elapsed since the inductor current flows in a direction that is opposite to a direction in which the inductor current flows when the first transistor is on, wherein the predetermined time period is calculated based on the ON period and a time period from when the first transistor is turned off until when the inductor current reaches the first predetermined value.

### BRIEF DESCRIPTION OF THE DRAWINGS

FIG. 1 is a diagram illustrating an example of an AC-DC converter 10.

FIG. 2 is a diagram illustrating an example of a power factor correction IC 26.

FIG. 3 is a diagram illustrating an example of a switching control circuit 203.

FIG. 4 is a diagram illustrating an example of an operation of a switching control circuit 203 in mode A.

FIG. 5 is a diagram illustrating main waveforms of an AC-DC converter 10.

FIG. 6 is a diagram illustrating an example of an operation of a switching control circuit 203 in mode B.

FIG. 7 is a diagram illustrating an example of an operation of a switching control circuit 203 in mode C.

FIG. 8 is a diagram illustrating an example of the relationship between the phase angle of an alternating current (AC) voltage Vac and modes A to C.

FIG. 9A is a diagram illustrating an example of the relationship between an ON period and Ton modes A to C.

FIG. 9B is a diagram illustrating an example of the relationship between an output period Tout and modes A to C.

FIG. 10 is a diagram of an example illustrating conditions when transitioning among modes A to C.

FIG. 11A is a diagram illustrating switching loss and conduction loss in a typical power factor correction circuit.

FIG. 11B is a diagram illustrating switching loss and conduction loss when operating in modes A to C.

### DETAILED DESCRIPTION

At least following matters will become apparent from the descriptions of the present description and the accompanying drawings. It is assumed, hereinafter, that a “circuit” according to an embodiment of the present disclosure includes not only an analog circuit and a logic circuit of a wired logic type, but also a functional block (or means) that is included in a digital signal processor (DSP), a microcomputer, or the like, and that is capable of executing digital arithmetic processing.

Hereinafter, embodiments of the present disclosure will be described with reference to the drawings. The same or equivalent constituent elements, members, and the like illustrated in the drawings are given the same reference numerals, and repetitive description is omitted as appropriate.

### Embodiments

### <<<Overview of AC-DC Converter 10>>>

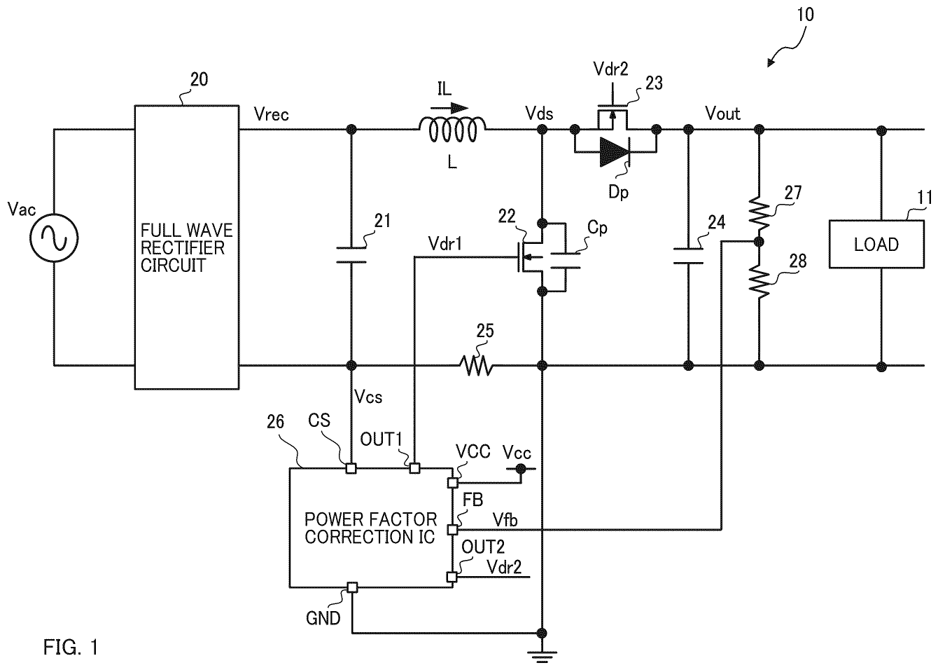

FIG. 1 is a diagram illustrating a configuration of an AC-DC converter 10 which is an embodiment of the present disclosure. The AC-DC converter 10 is a boost power factor correction (PFC) circuit that generates an output voltage Vout at a target level from an alternating-current (AC) voltage Vac of a commercial power supply.

The AC-DC converter 10 includes a full-wave rectifier circuit 20, capacitors 21, 24, a coil L, an NMOS transistors 22, 23, a resistor 25, a power factor correction IC 26, and resistors 27, 28. Note that the AC-DC converter 10 corresponds to a “power supply circuit”.

The full-wave rectifier circuit 20 full-wave rectifies a predetermined AC voltage Vac inputted thereto, and outputs a resultant voltage to the capacitor 21 and the coil L as an input voltage Vrec. Note that the AC voltage Vac is a voltage with an effective value in a range of 100 to 240 V and a frequency in a range of 50 to 60 Hz, for example. Hereinafter, in an embodiment of the present disclosure, a voltage basically refers to a difference in potential with respect to a reference point (GND in FIG. 1), however, the AC voltage Vac refers to a voltage across terminals. Note that the rectified voltage Vrec corresponds to a “full-wave rectified voltage”.

The capacitor 21 is an element that smooths the input voltage Vrec, and the capacitor 24 is an element to be charged with the output voltage of a boost chopper circuit. The coil L and the NMOS transistors 22, 23 configure the boost chopper circuit together with the capacitor 24. Thus, the charge voltage of the capacitor 24 results in the direct current (DC) output voltage Vout.

Further, it is assumed that when the inductor current IL flows through the coil L in the direction of an arrow (first direction), the direction in which the inductor current IL flows is a positive direction, and when the inductor current IL flows in the direction opposite to the direction of the arrow, the direction in which the inductor current IL flows is a negative direction. Note that the coil L corresponds to a “first inductor”.

The resistor 25 is an element to detect the current flowing through the NMOS transistor 22 and the current flowing via the load 11, and has one end connected to the source terminal of the NMOS transistor 22 and the ground, and the other end connected to the full-wave rectifier circuit 20 and a terminal CS of the power factor correction IC 26.

The power factor correction IC 26 is an integrated circuit that controls switching of the NMOS transistor 22 such that the level of the output voltage Vout achieves a target level (for example, 400 V) while improving the input power factor of the AC-DC converter 10. Specifically, the power factor correction IC 26 drives the NMOS transistor 22, based on the inductor current IL flowing through the coil L and the output voltage Vout. Note that the coil L corresponds to an “inductor”.

The power factor correction IC 26 controls switching of the NMOS transistor 23 as well, which will be described in detail later.

The NMOS transistor 22 is a power transistor to control power to the load 11 of the AC-DC converter 10. Note that in an embodiment of the present disclosure, the NMOS transistor 22 is an n-type metal oxide semiconductor (NMOS) transistor, but it is not limited thereto, and may be another switching element such as a bipolar transistor or the like, for example. Further, the gate electrode of the NMOS transistor 22 is connected to a terminal OUT1. Further, the NMOS transistor 22 has a parasitic capacitor Cp. Note that the “NMOS transistor 22” corresponds to a “first transistor”.

The NMOS transistor 23 is a power transistor to control power to the load 11 together with the NMOS transistor 22, and is switched complementarily to the NMOS transistor 22. Further, the NMOS transistor 23 has a parasitic diode Dp with an anode on the source side and a cathode on the drain side. Further, when the NMOS transistors 22, 23 are off, the inductor current IL flowing from the coil L to the capacitor 24 flows via the parasitic diode Dp of the NMOS transistor 23. Further, the gate electrode of the NMOS transistor 23 is coupled to a terminal OUT2. Note that the “NMOS transistor 23” corresponds to a “second transistor”.

The resistors 27, 28 configure a voltage divider circuit that divides the output voltage Vout, to thereby generate a feedback voltage Vfb that is used in switching the NMOS transistor 22. Note that the feedback voltage Vfb generated at the node at which the resistors 27, 28 are coupled is applied to a terminal FB.

### <<<Power Factor Correction IC 26>>>

### ==Configuration of Power Factor Correction IC 26==

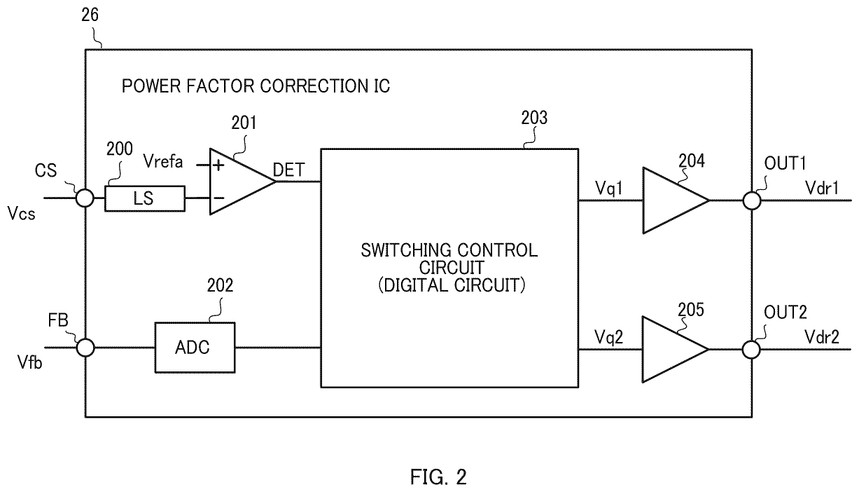

FIG. 2 is a diagram illustrating an example of the power factor correction IC 26. The power factor correction IC 26 includes a level shifter (LS) 200, a comparator 201, an analog-to-digital converter (ADC: AD converter) 202, a switching control circuit 203, and buffer circuits 204, 205. Note that the switching control circuit 203 is configured with a digital circuit.

The level shifter 200 level-shifts a voltage Vcs, and the comparator 201 compares the level-shifted voltage Vcs with a reference voltage Vrefa, to thereby output a signal DET. Specifically, in response to the voltage value of the voltage Vcs corresponding to the inductor current IL reaching a predetermined value, the comparator 201 outputs the high signal DET indicating that the inductor current IL decreases to substantially zero (hereinafter, “substantially zero” will be referred to simply as “zero”, for convenience). Note that the reference voltage Vrefa is the level-shifted voltage Vcs when the inductor current IL reaches zero (i.e., when the voltage value of the voltage Vcs reaches a predetermined value), and the predetermined value corresponds to a “first predetermined value”. Further, the voltage Vcs may be a digital signal indicating whether the inductor current IL is flowing. Moreover, the AD converter 202 converts the feedback voltage Vfb into a digital value.

The switching control circuit 203 is a circuit that outputs a drive signal Vq1 to drive the NMOS transistors 22, based on the feedback voltage Vfb and the voltages Vcs corresponding to the inductor current IL. The switching control circuit 203 is a digital circuit configured with a logic circuit of a wired logic type to execute various arithmetic calculations, and includes, for example, a logic gate, a flip-flop, and a memory. However, the switching control circuit 203 may be a digital signal processor (DSP) or a microcomputer. Note that details of the switching control circuit 203 will be described later.

Further, the switching control circuit 203 outputs a drive signal Vq2 to drive the NMOS transistor 23, which will be described in detail later.

The buffer circuit 204 is a driver circuit to drive the NMOS transistor 22, in response to the drive signal Vq1. Specifically, the buffer circuit 204 turns on the NMOS transistor 22, in response to the drive signal Vq1 going high (hereinafter, referred to as high or high level), and turns off the NMOS transistor 22, in response to the drive signal Vq1 going low (hereinafter, referred to as low or low level),

Further, the buffer circuit 205 is a driver circuit to drive the NMOS transistor 23 in response to the drive signal Vq2. Specifically, the buffer circuit 205 turns on the NMOS transistor 23, in response to the drive signal Vq2 going high, and turns off the NMOS transistor 23, in response to the drive signal Vq2 going low.

### ==Configuration of Switching Control Circuit 203==

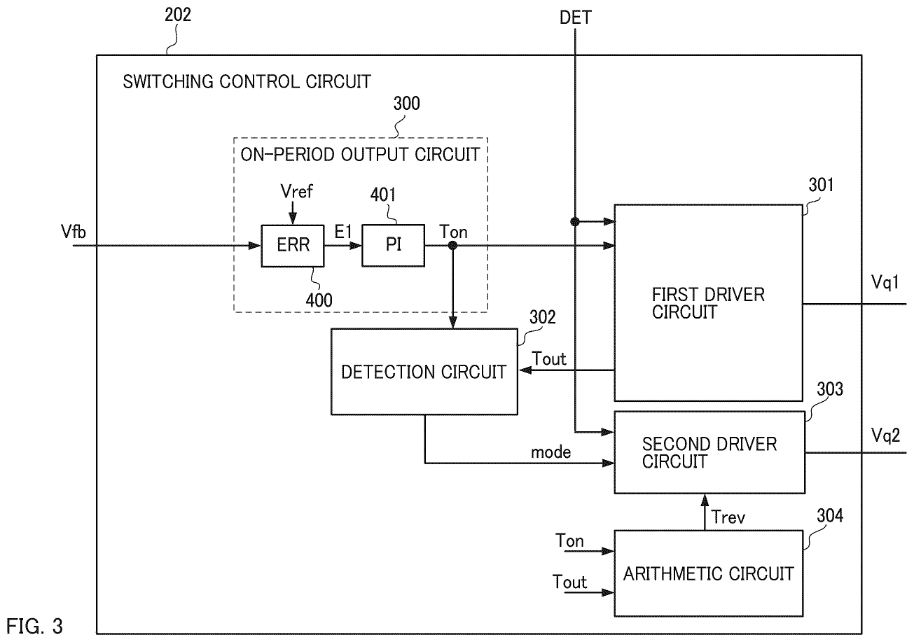

FIG. 3 is a diagram illustrating an example of the switching control circuit 203. The switching control circuit 203 outputs the drive signal Vq2 to drive the NMOS transistor 23, and outputs the drive signal Vq1 to drive the NMOS transistor 22, based on the inductor current IL and the feedback voltage Vfb.

Specifically, when the load 11 is in a light load state, the switching control circuit 203 switches the NMOS transistor 22 in mode A. Further, when the load 11 is in a heavy load state, the switching control circuit 203 switches the NMOS transistor 22 in mode B or mode C. Specifically, when the load 11 is in the heavy load state and the instantaneous value of the AC voltage Vac does not exceed half of the output voltage Vout, the switching control circuit 203 switches the NMOS transistor 22 in mode B, and when the instantaneous value of the AC voltage Vac exceeds half of the AC voltage Vac, switches the NMOS transistor 22 in mode C.

Further, as will be described in detail later, mode A is a mode in which the switching control circuit 203 performs a critical operation with the parasitic diode Dp of the NMOS transistor 23 serving as a diode. Mode B is a mode in which the switching control circuit 203 switches the NMOS transistor 23 complementarily to the NMOS transistor 22, to thereby perform synchronous rectification. Mode C is a mode in which the switching control circuit 203 performs synchronous rectification so as to perform zero voltage switching of the NMOS transistor 22. Note that mode A corresponds to a “first mode”, mode B corresponds to a “second mode” and a “first synchronous rectification mode”, and mode C corresponds to a “second synchronous rectification mode”.

The load 11 being in the light load state refers to, for example, a state in which the current flowing through the load 11 is smaller than a predetermined value (for example, 0.1 A) and the ON period Ton, which will be described later, is shorter than a predetermined time period Ton0. Meanwhile, the load being in the heavy load state refers to, for example, a state in which the current steadily flowing through the load 11 is larger than the predetermined value (for example, 0.1 A) and the ON period Ton exceeds the predetermined time period Ton0. Note that the predetermined time period Ton0 corresponds to a “first time period”.

The switching control circuit 203 includes an ON period output circuit 300, a first driver circuit 301, a detection circuit 302, a second driver circuit 303, and an arithmetic circuit 304.

The ON period output circuit 300 is a circuit that outputs information indicating the ON period Ton of the NMOS transistor 22 (hereinafter, simply referred to as ON period Ton), based on the feedback voltage Vfb.

The ON period output circuit 300 includes an error amplifier circuit (ERR) 400 and a PI control circuit (PI) 401. Note that the term “ON period” refers to a digital value indicating a voltage, for example.

The error amplifier circuit 400 calculates an error E1, which is the difference between the reference voltage Vref serving as the reference of the output voltage Vout at the target level (for example, 400 V) and the feedback voltage Vfb. Note that the feedback voltage Vfb is a digital value obtained by converting the feedback voltage Vfb by the AD converter 202

The PI control circuit 401 calculates the integral value of the error E1 and the proportional value of the error E1, and outputs the ON period Ton for causing the level of the feedback voltage Vfb to be equal to the level of the reference voltage Vref, based on the integral value and the proportional value.

### ===Driver Circuit 301===

The first driver circuit 301 drives the NMOS transistor 22, based on the drive signal Vq1 corresponding to the inputted ON period Ton. Specifically, in response to the inductor current IL decreasing to zero and the comparator 201 outputting the high signal DET, the first driver circuit 301 outputs the drive signal Vq1 to turn on the NMOS transistor 22 after a lapse of a delay time Tdelay.

Thereafter, the first driver circuit 301 outputs the drive signal Vq1 to turn off the NMOS transistor 22, in response to the ON period Ton having elapsed. Further, the first driver circuit 301 measures a time period from when the NMOS transistor 22 is turned off until when the comparator 201 outputs the high signal DET, to thereby output a resultant as an output period Tout. Note that the output period Tout refers to a time period for supplying the power stored by the coil L to the capacitor 24.

The detection circuit 302 is a circuit that detects the phase angle of the AC voltage Vac, based on the output period Tout. Specifically, as will be described in detail later, the detection circuit 302 detects, based on the ON period Ton and the output period Tout, the state of the load 11 and the phase, instantaneous value, and peak of the AC voltage Vac, to thereby output, based on these, a signal mode indicating any one of modes A to C. Note that the detection circuit 302 corresponds to a “detection circuit”.

### ===Second Driver Circuit 303===

The second driver circuit 303 outputs the signal Vq2 to turn on and off the NMOS transistor 23, based on the signal DET from the comparator 201, a reverse charge period Trev, which will be described later, and the signal mode. Specifically, the second driver circuit 303 outputs the drive signal Vq2 to turn off the NMOS transistor 23, in response to the signal mode indicating mode A, and outputs the drive signal Vq2 to turn on and off the NMOS transistor 23 complementarily to the NMOS transistor 22, in response to the signal mode indicating mode B, C.

The arithmetic circuit 304 is a circuit that calculates the reverse charge period Trev, based on the ON period Ton and the output period Tout, when the switching control circuit 203 operates in mode C. The reverse charge period Trev is a time period during which the NMOS transistor 23 is kept on after the NMOS transistor 22 is turned off and the inductor current IL reaches zero, which will be described in detail later.

### ==Operation in Modes A to C==

The following firstly describes the operations of the switching control circuit 203 in modes A to C, and then describes under what condition the switching control circuit 203 operates in which one of modes A to C.

### ===Operation in Mode A===

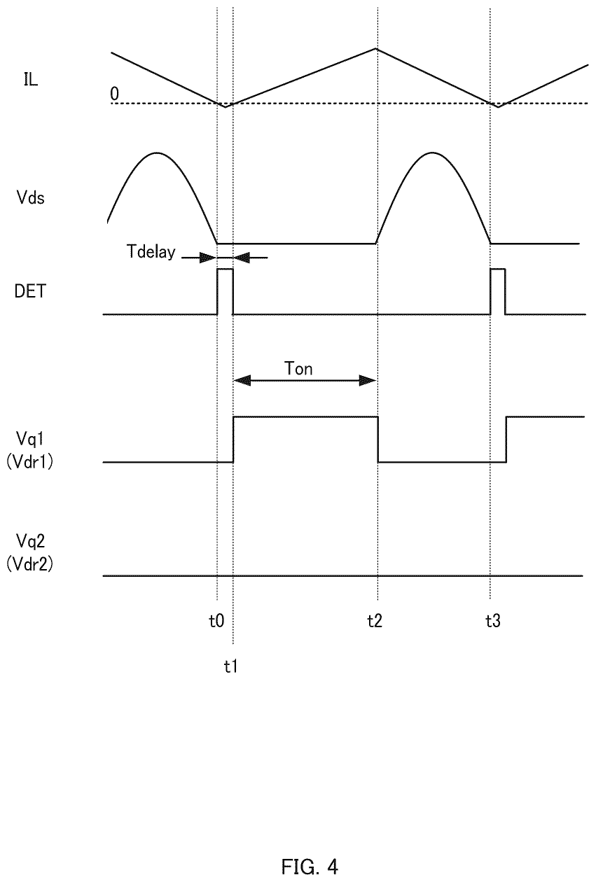

FIG. 4 is a diagram illustrating an example of the operation of the switching control circuit 203 in mode A. Note that when the switching control circuit 203 operates in mode A, the second driver circuit 303 outputs the drive signal Vq2 to turn off the NMOS transistor 23. Thus, the output voltage Vout of the AC-DC converter 10 is generated based on the inductor current IL flowing through the parasitic diode Dp of the NMOS transistor 23.

First, in response to the inductor current IL decreasing to zero at time t0, the comparator 201 changes the signal DET to high. Then, at time t1 at which the delay time Tdelay has elapsed since time t0, the first driver circuit 301 outputs the high signal Vq1.

In response to the drive signal Vq1 going high, the NMOS transistor 22 is turned on, and thus the inductor current IL increases.

Further, at time t2, at which the ON period Ton has elapsed since the drive signal Vq1 goes high, the first driver circuit 301 outputs the low drive signal Vq1 to turn off the NMOS transistor 22. As a result, the inductor current IL gradually decreases. Further, in response to the inductor current IL decreasing to zero at time t3, the operation from time t0 is repeated.

Here, when the AC-DC converter 10 is generating the output voltage Vout at the target level from the predetermined AC voltage Vac, the capacitance value of the capacitor 24 is sufficiently large and the feedback voltage Vfb is substantially constant within a time period corresponding to about one period of Vac. As a result, the ON period Ton outputted from the ON period output circuit 300 also becomes substantially constant, and thus the time period during which the NMOS the transistor 22 is on (for example, the time period from time t1 to t2) results in being substantially constant as well.

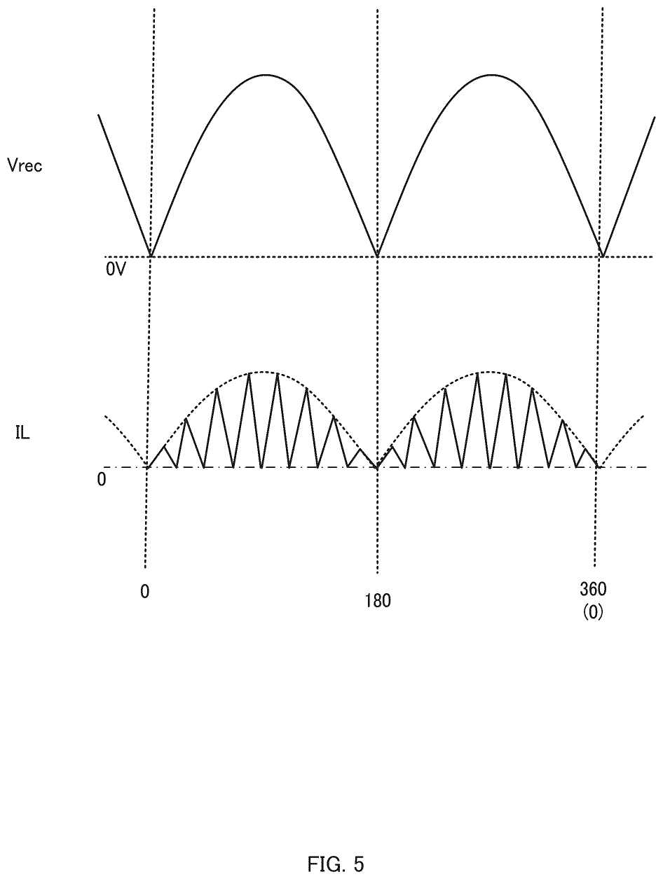

Further, the current value of the inductor current IL increases in response to a rise in the level of the voltage Vrec obtained by rectifying the AC voltage Vac, when the NMOS transistor 22 is turned on. As a result, as illustrated in FIG. 5, the waveform of the peak values of the inductor current IL results in being similar to the waveform of the voltage Vrec. This will improve power factor.

### ===Operation in Mode B===

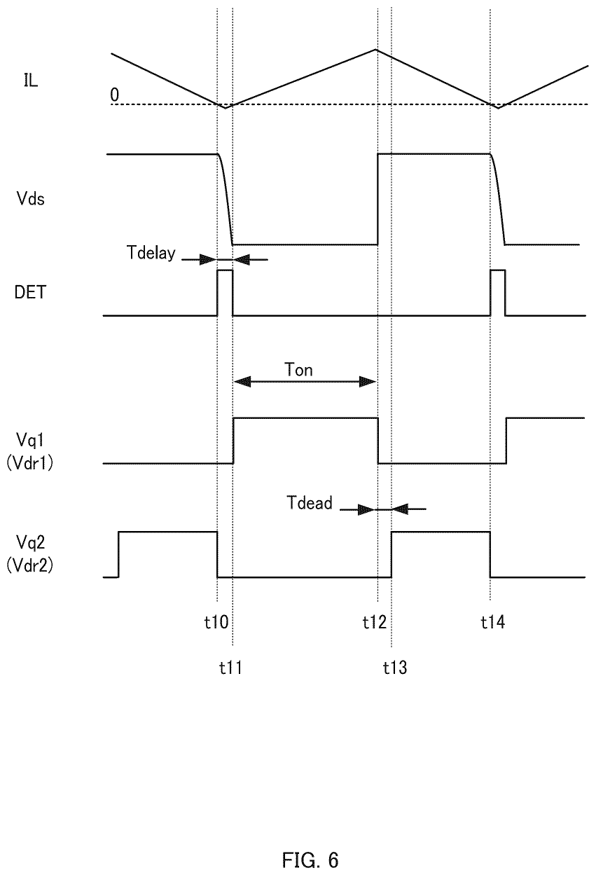

FIG. 6 is a diagram illustrating an example of the operation of the switching control circuit 203 in mode B. Note that when the switching control circuit 203 operates in mode B, the second driver circuit 303 outputs the drive signal Vq2 to turn on and off the NMOS transistor 23 complementarily to the NMOS transistor 22.

First, in response to the inductor current IL decreasing to zero at time t10, the comparator 201 changes the signal DET to high. In association therewith, the second driver circuit 303 outputs the low signal Vq2, to thereby turn off the NMOS transistor 23. Then, at time t12, at which the delay time Tdelay has elapsed since time t10, the first driver circuit 301 outputs the high signal Vq1.

In response to the drive signal Vq1 going high, the NMOS transistor 22 is turned on, and thus the inductor current IL increases.

Further, at time t12, at which the ON period Ton has elapsed since the drive signal Vq1 goes high, the first driver circuit 301 outputs the low drive signal Vq1 to turn off the NMOS transistor 22. As a result, the inductor current IL gradually decreases.

At time t13, at which a dead time Tdead has elapsed since time t12, the second driver circuit 303 outputs the high drive signal Vdr2, to thereby turn on the NMOS transistor 23.

At time t14, at which the inductor current IL decreases to zero, the comparator 201 changes the signal DET to high, and the second driver circuit 303 outputs the low drive signal Vq2 to turn off the NMOS transistor 23. From time t14, the same operation will be repeated.

As such, with the NMOS transistors 22, 23 being turned on and off complementarily, the inductor current IL flows to the capacitor 24 via the NMOS transistor 23 instead of the parasitic diode Dp. As a result, conduction loss does not correspond to the amount of forward voltage of the parasitic diode Dp but corresponds to the amount of the on-resistance of the NMOS transistor 23. Thus, conduction loss is reduced. Note that the size of the NMOS transistor 23 is designed such that the loss by the on-resistance is smaller than the loss by the parasitic diode Dp, and the gate voltage is also determined.

### ===Operation in Mode C===

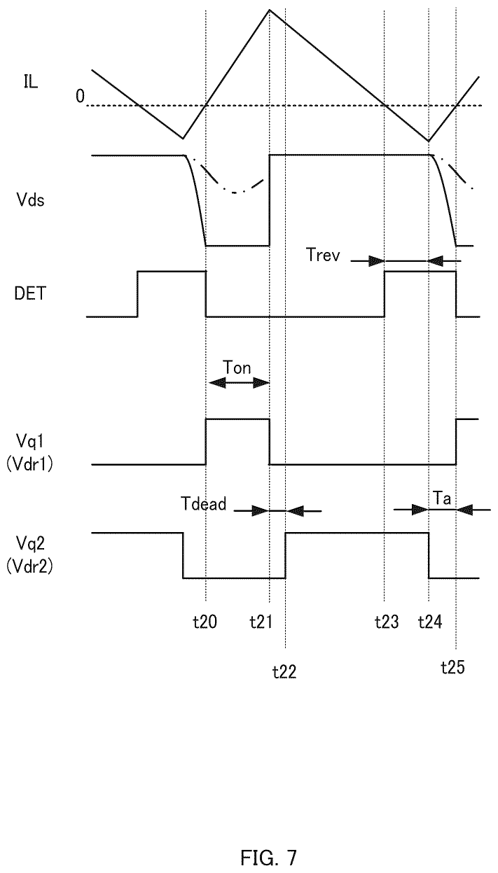

FIG. 7 is a diagram illustrating an example of the operation of the switching control circuit 203 in mode C. Note that when the switching control circuit 203 operates in mode C, the second driver circuit 303 outputs the drive signal Vq2 to turn on and off the NMOS transistor 23 complementarily to the NMOS transistor 22.

Further, usually, the switching control circuit 203 operates in mode C when the load 11 is in the heavy load state and the phase angle of the AC voltage Vac is high. Thus, if the switching control circuit 203 operates in the same manner as in mode B, the drain-source voltage Vds of the NMOS transistor 22 when the NMOS transistor 22 is turned on does not drop sufficiently as given by the dashed-dotted line. Accordingly, the switching loss of the NMOS transistor 22 increases. Thus, as will be described below, when the switching control circuit 203 operates in mode C, the reverse charge period Trev is provided.

First, at time t20, the first driver circuit 301 outputs the high signal Vq1. In response to the drive signal Vq1 going high, the NMOS transistor 22 is turned on, and thus the inductor current IL increases.

Further, at time t21, at which the ON period Ton has elapsed since the drive signal Vq1 goes high, the first driver circuit 301 outputs the low drive signal Vq1 to turn off the NMOS transistor 22. As a result, the inductor current IL gradually decreases. While the inductor current IL decreases, the voltage Vds remains at a high voltage level.

At time t22, at which the dead time Tdead has elapsed since the time t21, the second driver circuit 303 outputs the high drive signal Vq2, to turn on the NMOS transistor 23.

At time t23, at which the inductor current IL decreases to zero, the comparator 201 changes the signal DET to high. The second driver circuit 303 starts measuring time of the reverse charge period Trev, which will be described in detail later. Note that the reverse charge period Trev refers to a time period for performing zero voltage switching of the NMOS transistor 22 even when the load 11 is in the heavy load state.

At time t24, at which the reverse charge period Trev has elapsed since time t23, the second driver circuit 303 outputs the low drive signal Vq2, to turn off the NMOS transistor 23. Further, the voltage Vds starts to drop because the inductor current IL stops decreasing.

Here, the voltage level of the output voltage Vout is higher than the voltage level of the rectified voltage Vrec, and thus the inductor current IL flows in the negative direction during the reverse charge period Trev. Then, in response to the NMOS transistor 23 being turned off at time t24, the inductor current IL flowing through the coil L tries to continue to flow in the negative direction, and thus charge is drawn from the parasitic capacitor Cp of the NMOS transistor 22, and the drain-source voltage Vds of the NMOS transistor 22 drops to around 0 V. Note that the reverse charge period Trev corresponds to a “predetermined time period”.

At time t25, at which the predetermined time period Ta has elapsed since time t24, the first driver circuit 301 outputs the high signal Vq1. And, the voltage Vds drops to 0V. As such, in a state in which the drain-source voltage Vds has been lowered to 0 V, the NMOS transistor 22 is turned on, thereby reducing the switching loss of the NMOS transistor 22. From time t25, the same operation will be repeated.

When the switching control circuit 203 operates in mode C, zero voltage switching is implemented and the switching the loss of the NMOS transistor 22 is reduced, and thus the loss of the AC-DC converter 10 is reduced to the same extent as in mode B, in which the NMOS transistor 22 is switched in response to the voltage Vds reaching 0 V. Meanwhile, when the switching control circuit 203 operates in mode A, the switching of the NMOS transistor 23 is repeated in a short period of time, and the switching loss of the NMOS transistor 23 increases, and thus the NMOS transistor 23 is always controlled to be off.

### ===Calculation of Reverse Charge Period Trev===

Here, the reverse charge period Trev calculated by the arithmetic circuit 304 will be described. First, the inductor current IL is given by the following Expressions (1) and (2) when the NMOS transistor 22 is turned on and when the NMOS transistor 22 is turned off.

$$IL = Vrec / L \times Ton \qquad Expression ( 1 )$$

$$IL = ( Vout - Vrec ) / L \times Tout \qquad Expression ( 2 )$$

where, L is the inductance value of the coil L.

Accordingly, the relationship between the ON period Ton and the output period Tout is given in Expression (3), based on Expressions (1) and (2).

$$Tout / Ton = Vrec / ( Vout - Vrec ) \qquad Expression ( 3 )$$

Then, a current value Irev of the inductor current IL flowing in the negative direction during the reverse charge period Trev is given by Expression (4) as follows.

$$Irev = ( Vout - Vrec ) / L \times Trev \qquad Expression ( 4 )$$

When the NMOS transistor 23 is turned off, the output voltage Vout is applied to the parasitic capacitor Cp, and the rectified voltage Vrec is applied to the capacitor 21. Further, if it is assumed that the capacitance value of the capacitor 21 is sufficiently larger than the capacitance value of the parasitic capacitor Cp, then the parasitic capacitor Cp and the coil L are involved in the resonant operation. When an ideal state is taken into consideration, the relationship between the resonant current I and the resonant voltage V is given by the following Expression (5), based on the law of conservation of energy.

$$1 / 2 \times Cp \times V \hat{} 2 + 1 / 2 \times L \times I \hat{} 2 = 1 / 2 \times Cp \times ( Vout - Vrec ) \vert \hat{} 2 + 1 / 2 \times L \times Irev \hat{} 2 \qquad Expression ( 5 )$$

where Cp is the capacitance value of the parasitic capacitor Cp.

Then, in Expression (5), when zero voltage switching is taken into consideration, the resonant current I reaches zero and the resonant voltage V reaches the rectified voltage Vrec, at the lower peak of the resonant operation. Accordingly, the current value Irev min of the inductor current IL flowing in the negative direction in this case is given by Expression (6) as follows.

$$Irev\_min = \sqrt{} \{ Cp / L \times [ Vrec \hat{} 2 - ( Vout - Vrec ) \hat{} 2 ] \} \qquad Expression ( 6 )$$

Then, from Expressions (3), (4), and (6), the reverse charge period Trev to turn off the NMOS transistor 23 at the lower peak of the resonant operation is calculated as in Expression (7) as follows.

$$\begin{matrix}Trev = \sqrt{} ⌈ L \times Cp \times \{ [ Vrec \hat{} 2 / ( Vout - Vrec ) \hat{} 2 - 1 ] \} ⌋ \\ = \sqrt{} ( L \times Cp ) \times \sqrt{} \{ [ Vrec / ( Vout - Vrec ) ] \hat{} 2 - 1 \} \\ = \sqrt{} ( L \times Cp ) \times \sqrt{} [ ( Tout / Ton ) \hat{} 2 - 1 ]\end{matrix} \qquad Expression ( 7 )$$

==Condition for Switching among Modes A to C and Operation of Detection Circuit 302==

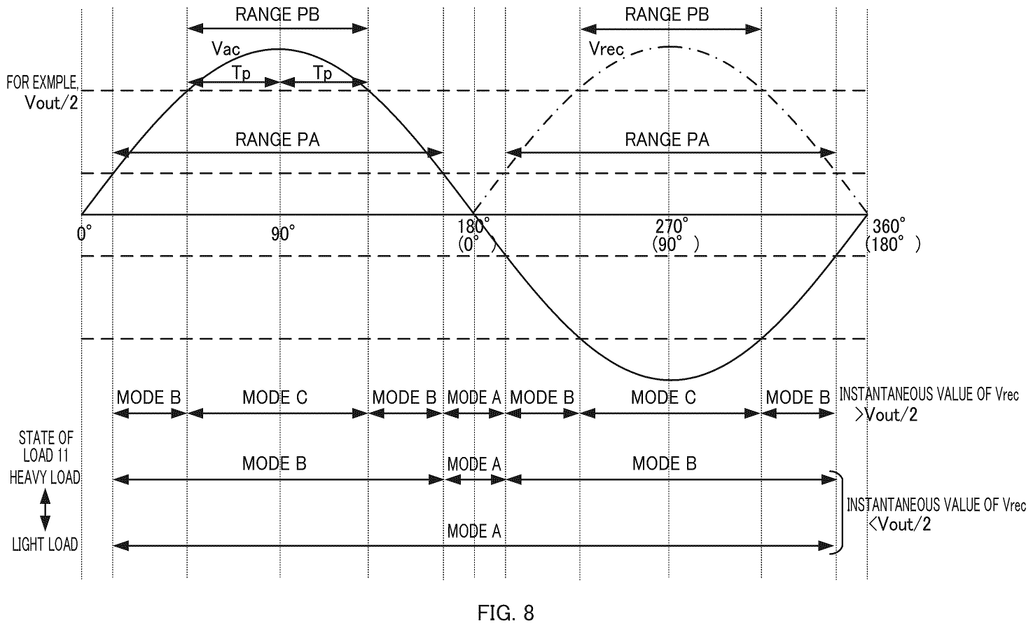

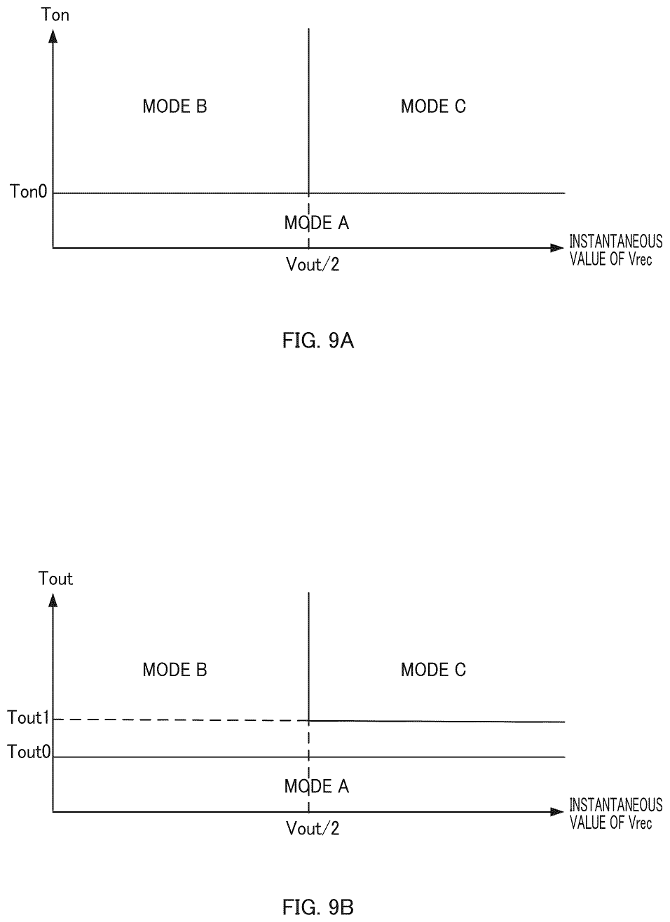

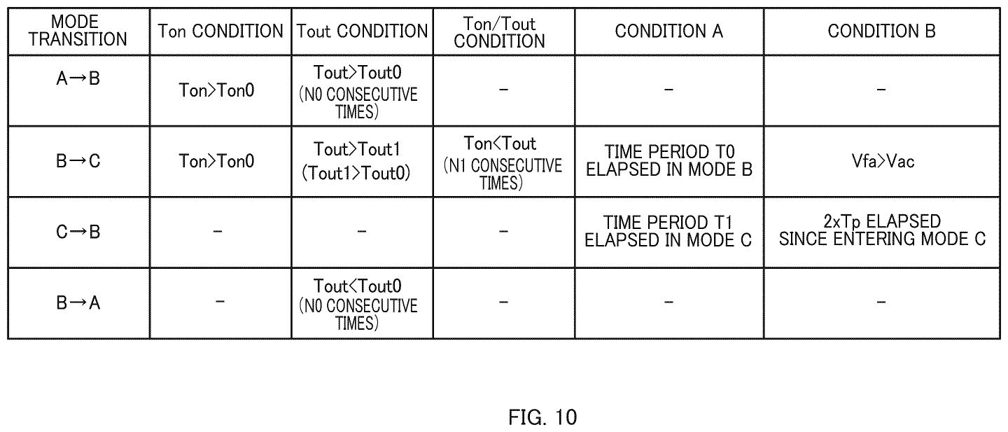

FIG. 8 is a diagram illustrating an example of the relationship between the phase angle of the AC voltage Vac and modes A to C. FIG. 9A is a diagram illustrating an example of the relationship between the ON period Ton and modes A to C. FIG. 9B is a diagram illustrating an example of the relationship between the output period Tout and modes A to C. FIG. 10 is a diagram illustrating an example of condition for transition among modes A to C. The condition for switching the operation mode of the switching control circuit 203 to any one of modes A to C and the operation of the detection circuit 302 will be described with reference to FIGS. 8 to 10.

As illustrated in FIG. 8, the detection circuit 302 detects the state of the load 11, the phase, instantaneous value, and peak of the AC voltage Vac, based on the ON period Ton and the output period Tout, to thereby output the signal mode indicating any one of modes A to C.

### ===Detection of State of Load 11===

As illustrated in 9A, when the ON period Ton is shorter than the predetermined time period Ton0, the detection circuit 302 detects that the load 11 is in the light load state, to thereby output the signal mode indicating mode A. Meanwhile, when the phase angle of the AC voltage Vac is a medium phase angle, the peak value of the inductor current IL increases, and the output period Tout increases. Then, as illustrated in FIG. 10, in response to the state in which the output period Tout exceeds the predetermined time period Tout0 occurring NO consecutive times in the number of times of switching of the NMOS transistor 22, the detection circuit 302 detects that the load 11 is in the heavy load state, based on the that the ON period Ton exceeds the predetermined time period Ton0, to thereby output the signal mode indicating mode B. Note that NO times may be one time, but by setting it to multiple times, it is possible to suppress frequent switching between modes A and B when the state of the load 11 changes between the light load state and the heavy load state.

Accordingly, the detection circuit 302 may always output the signal mode indicating mode A, as illustrated in FIG. 9A, when the ON period Ton is short due to the load 11 being in the light load state. However, when the load 11 is in the heavy load state, the ON period Ton is longer than that when it is in the light load state, and as the phase angle of the AC voltage Vac increases, the peak value of the inductor current IL of will increase. As the peak value increases, the amount of the power stored in the coil L increases as well and the output period Tout increases, and thus the detection circuit 302 detects the phase angle of the AC voltage Vac, based on the output period Tout. Then, as illustrated in FIGS. 8 and 9B, when the output period Tout exceeds the time period Tout0 and the phase angle falls within a range PA, the detection circuit 302 outputs the signal mode indicating mode B. Note that the range PA corresponds to a “first range”, and the output period Tout corresponds to a “time period from when the first transistor is turned off until when the inductor current reaches the first predetermined value”.

Meanwhile, the detection circuit 302 outputs the signal mode indicating mode A, in response to the phase angle falling outside the range PA, as illustrated in FIG. 8. Furthermore, as illustrated in FIG. 10, when the state in which the output period Tout is shorter than the time period Tout0 occurs NO consecutive times in the number of times of the switching of the NMOS transistor 22, the detection circuit 302 detects that the load 11 is in the light load state, to thereby output the signal mode indicating mode A.

### ===Detection of Instantaneous Value of AC Voltage Vac===

The detection circuit 302 detects the instantaneous value of the input voltage Vrec, based on the ON period Ton and the output period Tout. Further, in response to the instantaneous value of the input voltage Vrec reaching half of the output voltage Vout, the ON period Ton will be equal to the output period Tout, as can be seen from the above-mentioned Expression (3).

Thus, as illustrated in FIGS. 9A, 9B, and 10, the detection circuit 302 outputs the signal mode indicating mode C, in response to the instantaneous value of the input voltage Vrec exceeding half of the output voltage Vout and the output period Tout exceeding the time period Tout1, which is the output period Tout when the ON period Ton is equal to the output period Tout. In this case, the phase angle of the AC voltage Vac is within a range PB, as illustrated in FIG. 8. In this case, the ON period Ton exceeds the predetermined time period Ton0. Note that half of the output voltage Vout corresponds to a “predetermined level”, and the range PB corresponds to a “second range”.

As illustrated in FIG. 10, further conditions include conditions that the state in which the ON period Ton is shorter than the output period Tout occurs Ni consecutive times; the time period TO has elapsed while operating in mode B; and the feedback voltage Vfb is higher than a voltage Vac. Note that the time period Tout1 exceeds the time period Tout0. Further, the time period TO corresponds to a “second time period”, and the feedback voltage Vfb being higher than the voltage Vac corresponds to a “predetermined condition”.

Meanwhile, when the instantaneous value of the input voltage Vrec is lower than half of the output voltage Vout, the detection circuit 302 outputs the signal mode indicating mode B if the output period Tout exceeds the predetermined time period Tout0, as illustrated in FIG. 9B.

### ===Detection of Peak of AC Voltage Vac===

Further, the detection circuit 302 detects the peak of the AC voltage Vac, based on the output period Tout. Specifically, the detection circuit 302 detects the peak of the AC voltage Vac, based on that when the ON period Ton is constant, the AC voltage output voltage Vac peaks, that is, when the phase angle reaches 90°, the output period Tout is the longest.

Then, as illustrated in FIG. 8, when a time period Tp, which is a time period from when the switching control circuit 203 starts operating in mode C to when the AC voltage Vac peaks, has elapsed since the AC voltage Vac has peaked, the detection circuit 302 outputs the signal mode indicating mode B. Further conditions include the time period T1 having elapsed since the switching control circuit 203 starts operating in mode C, as illustrated in FIG. 10. Note that the time period Tp corresponds to a “third time period” and the time period T1 corresponds to a “fourth time period”.

As such, the detection circuit 302 detects the state of the load 11, the phase, instantaneous value, and peak of the AC voltage Vac, based on the ON period Ton and the output period Tout, as illustrated in FIG. 8, and outputs the signal mode indicating any one of modes A to C. This makes it possible to provide a switching control circuit capable of reducing loss of the PFC circuit by switching among multiple operation modes.

### ==Advantage of Using Embodiment of the Present Disclosure==

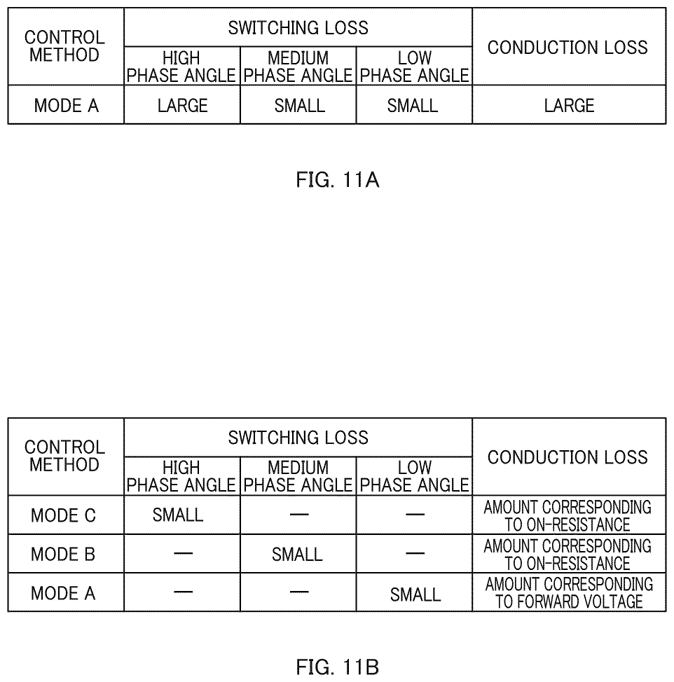

In the case where the NMOS transistor 23 is turned off and always operates in mode A, as illustrated in FIG. 11A, when the AC voltage Vac has a medium phase angle and low phase angle, the voltage Vds drops to around 0 V after the NMOS transistor 22 is turned off, and thus the switching loss of the NMOS transistor 22 is small.

Meanwhile, when the AC voltage Vac has a high phase angle, the voltage Vds does not drop to around 0 V after the NMOS transistor 22 is turned off, and thus the switching loss of the NMOS transistor 22 increases. Further, when the output voltage Vout is generated using the diode without using the NMOS transistor 23, the conduction loss in the diode increases.

In contrast, in the case of operating while switching among modes A to C, as illustrated in FIG. 11B, when the AC voltage Vac has a low phase angle, the switching loss of the NMOS transistor 22 is small, as in the case of the low phase angle in FIG. 11A. Further, in this case, the inductor current IL flows to the capacitor 24 via the parasitic diode Dp, which results in a conduction loss corresponding to an amount of the forward voltage of the parasitic diode Dp.

When the AC voltage Vac has a medium phase angle, the switching loss of the NMOS transistor 22 is small, as in the case of the medium phase angle in FIG. 11A. Further, in this case, when the inductor current IL flows to the capacitor 24, the NMOS transistor 23 is turned on, and thus the conduction loss results in an amount corresponding to the on-resistance of the NMOS transistor 23, and is reduced.

When the AC voltage Vac has a high phase angle, unlike the case of FIG. 11A, the reverse charge period Trev is provided before the NMOS transistor 23 is turned off, and thus zero voltage switching can be implemented and the switching loss of the NMOS transistor 22 is small. Further, in this case, as in the case of the medium phase angle, when the inductor current IL flows to the capacitor 24, the NMOS transistor 23 is turned on, and thus the conduction loss results in an amount corresponding to the on-resistance in the NMOS transistor 23 and is reduced.

From the above, with the switching control circuit 203 appropriately switching among modes A to C, the switching loss of the NMOS transistor 22 and the conduction loss of the diode are reduced, thereby reducing the overall loss of the AC-DC converter 10.

### SUMMARY

A description has been given of the AC-DC converter 10 according to an embodiment of the present disclosure. The switching control circuit 203 includes the first driver circuit 301 and the second driver circuit 303. Further, the second driver circuit 303 drives the NMOS transistor 23 in mode A or B, based on the ON period Ton of the NMOS transistor 22, which indicates the state of the load 11. Furthermore, when the ON period Ton exceeds the predetermined time period Ton0 and the switching control circuit 203 operates in mode B, conduction loss results in an amount corresponding to the on-resistance of the NMOS transistor 23. This makes it possible to provide a switching control circuit capable of reducing loss in the PFC circuit by switching among the multiple operation modes.

Further, the switching control circuit 203 includes the detection circuit 302, and the second driver circuit 303 drives the NMOS transistor 23 in mode B, based on the ON period Ton and the phase angle of the AC voltage Vac. In this case, the switching control circuit 203 operates in mode B, the phase angle is a medium phase angle and the output period Tout increases, and thus the NMOS transistor 23 and the NMOS transistor 22 are turned on and off complementarily. Accordingly, the inductor current IL flows to the capacitor 24 not via the parasitic diode Dp but via the NMOS transistor 23. This reduces conduction loss.

Further, the second driver circuit 303 turns off the NMOS transistor 23 in mode A, when the phase angle of the AC voltage Vac falls outside the range PA. In this case, when the phase angle is low, the output period Tout of the NMOS transistor 22 decreases, and the NMOS transistor 23 is turned on and off in a short period of time, and thus the NMOS transistor 23 is turned off. This makes it possible to reduce the switching loss of the NMOS transistor 23.

Further, the detection circuit 302 detects the phase angle of the AC voltage Vac, based on the output period Tout. Accordingly, with the voltage divider circuit and the like being provided outside the power factor correction IC 26, it is possible to detect the phase angle of the AC voltage Vac without directly detecting the AC voltage Vac.

Further, the switching control circuit 203 includes the first driver circuit 301 and the second driver circuit 303, and the second driver circuit 303 drives the NMOS transistor 23 in mode B or C. This makes it possible to provide a switching control circuit capable of reducing loss in the PFC circuit by switching among the multiple operation modes. Further, when driving the NMOS transistor 23 in mode C, the switching control circuit 203 discharges the parasitic capacitor Cp of the NMOS transistor 22, thereby being able to implement zero voltage switching.

Further, the second driver circuit 303 drives the NMOS transistor 23 in mode C, when the phase angle of the AC voltage Vac is within the range PB. Accordingly, when the phase angle of the AC voltage Vac increases, the switching loss of the NMOS transistor 22 caused by the voltage Vds not dropping to 0 V after the NMOS transistor 22 is turned off is reduced.

Further, the second driver circuit 303 drives the NMOS transistor 23 in mode C when the ON period Ton exceeds the predetermined Ton0. Accordingly, the switching control circuit 203 operates in mode C, only when the load 11 is in the heavy load state.

Further, the second driver circuit 303 drives the NMOS transistor 23 in mode C, after the time period TO has elapsed in mode B. This makes it possible to suppress frequent changes in the operation mode between mode B and mode C.

Further, the second driver circuit 303 drives the NMOS transistor 23 in mode C, in response to the feedback voltage Vfb exceeding the voltage Vac. Accordingly, the second driver circuit 303 drives the NMOS transistor 23 in mode C, only after the output voltage Vout rises to a certain extent and enters a steady state, that is, after the start-up of the AC-DC converter 10 is completed.

Further, in response to the time period Tp having elapsed since the peak of the AC voltage Vac passes after the second driver circuit 303 starts operating in mode C, the second driver circuit 303 drives the NMOS transistor 23 in mode B. This enables the second driver circuit 303 to drive the NMOS transistor 23 in mode C, only when the phase angle of the AC voltage Vac is in the range PB.

Further, the second driver circuit 303 drives the NMOS transistor 23 in mode B, after the time period T1 has elapsed in mode C. This makes it possible to suppress frequent changes in the operation mode between mode B and mode C.

Further, the switching control circuit 203 includes the first driver circuit 301 and the second driver circuit 303, and the second driver circuit 303 turns off the NMOS transistor 23, in response to the inductor current IL flowing in the negative direction and the reverse charge period Trev having elapsed. Accordingly, when driving the NMOS transistor 23 in mode C, the switching control circuit 203 discharges the parasitic capacitor Cp of the NMOS transistor 22, thereby being able to implement zero voltage switching.

The present disclosure is directed to provision of a switching control circuit capable of reducing loss in a PFC circuit by switching among a plurality of operating modes.

According to the present disclosure, it is possible to provide a switching control circuit capable of reducing loss in a PFC circuit by switching among a plurality of operation modes.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

What is claimed is:

1. A switching control circuit for a power supply circuit that generates an output voltage at a target level from an alternating current (AC) voltage inputted thereto, the power supply circuit including
an inductor configured to receive a voltage corresponding to the AC voltage,
a first transistor configured to control an inductor current flowing through the inductor, and
a second transistor connected to the inductor and the first transistor,
the switching control circuit being configured to control switching of the first and second transistors, the switching control circuit comprising:
a first driver circuit configured to
turn on the first transistor after the inductor current reaches a first predetermined value, and
turn off the first transistor in response to an ON period corresponding to the output voltage having elapsed;
a second driver circuit configured to,
in response to the ON period of the first transistor being shorter than a fist time period, drive the first transistor in a first mode, the first mode being a mode in which the first transistor is switched in a state where the second transistor is kept off, and
in response to the ON period of the first transistor exceeding the first time period, drive the second transistor in a second mode, the second mode being a mode in which the second transistor is switched complementarily to the first transistor.

2. The switching control circuit according to claim 1, further comprising:
a detection circuit configured to detect a phase angle of the AC voltage, wherein
the second driver circuit drives the second transistor in the second mode, in response to the ON period exceeding the first time period and the phase angle of the AC voltage falling in a first range.

3. The switching control circuit according to claim 2,
wherein the second driver circuit further drives the second transistor in the first mode in response to the phase angle of the AC voltage falling outside the first range.

4. The switching control circuit according to claim 3,
wherein the detection circuit detects the phase angle, based on a time period from when the first transistor is turned off until when the inductor current reaches the first predetermined value.

5. A switching control circuit for a power supply circuit that generates an output voltage at a target level from an alternating current (AC) voltage inputted thereto, the power supply circuit including
an inductor configured to receive a voltage corresponding to the AC voltage,
a first transistor configured to control an inductor current flowing through the inductor, and
a second transistor connected to the inductor and the first transistor,
the switching control circuit being configured to control switching of the first and second transistors, the switching control circuit comprising:
a first driver circuit configured to
turn on the first transistor after the inductor current reaches a first predetermined value, and
turn off the first transistor in response to an ON period corresponding to the output voltage having elapsed; and
a second driver circuit configured to
drive the second transistor in a first synchronous rectification mode, in response to an instantaneous value of a full-wave rectified voltage dropping below a predetermined level corresponding to the output voltage, the full-wave rectified voltage being obtained by full-wave rectifying the AC voltage, and
drive the second transistor in a second synchronous rectification mode, in response to the instantaneous value exceeding the predetermined level,
wherein
the first synchronous rectification mode is a mode in which the second transistor is switched complementarily to the first transistor, and
the second synchronous rectification mode is a mode in which
the second transistor is turned on after the first transistor is turned off, and
the second transistor is turned off, in response to a predetermined time period having elapsed since the inductor current flows in a direction that is opposite to a direction in which the inductor current flows when the first transistor is on.

6. The switching control circuit according to claim 5, wherein the second driver circuit drives the second transistor in the second synchronous rectification mode, when a phase angle of the AC voltage is within a predetermined range including 90°.

7. The switching control circuit according to claim 6, wherein the second driver circuit drives the second transistor in the second synchronous rectification mode, when the ON period exceeds a first time period.

8. The switching control circuit according to claim 7, wherein the second driver circuit drives the second transistor in the second synchronous rectification mode, after the first synchronous rectification mode continues for a second time period.

9. The switching control circuit according to claim 7, wherein the second driver circuit drives the second transistor in the second synchronous rectification mode, in response to a feedback voltage corresponding to the output voltage satisfying a predetermined condition.

10. The switching control circuit according to claim 8, wherein the second driver circuit drives the second transistor in the first synchronous rectification mode, in response to a third time period has elapsed after the phase angle reaches 90°, the third time period being at time period from when an operation in the second synchronous rectification mode starts until when the phase angle reaches 90°.

11. The switching control circuit according to claim 10, wherein the second driver circuit drives the second transistor in the first synchronous rectification mode, after a fourth time period, which is an operation period in the second synchronous rectification mode, has elapsed.

12. The switching control circuit according to claim 5, wherein the second driver circuit
drives the second transistor in the first synchronous rectification mode, in response to the instantaneous value dropping below a half of the output voltage, and
drives the second transistor in the second synchronous rectification mode, in response to the instantaneous value exceeding a half of the output voltage.

13. A switching control circuit for a power supply circuit that generates an output voltage at a target level from an alternating current (AC) voltage inputted thereto, the power supply circuit including
an inductor configured to receive a voltage corresponding to the AC voltage,
a first transistor configured to control an inductor current flowing through the inductor, and
a second transistor connected to the inductor and the first transistor,
the switching control circuit being configured to control switching of the first and second transistors, the switching control circuit comprising:
a first driver circuit configured to
turn on the first transistor after the inductor current reaches a first predetermined value, and
turn off the first transistor, in response to an ON period corresponding to the output voltage having elapsed; and
a second driver circuit configured to
turn on the second transistor after the first transistor is turned off, and
turn off the second transistor, in response to a predetermined time period having elapsed since the inductor current flows in a direction that is opposite to a direction in which the inductor current flows when the first transistor is on, wherein
the predetermined time period is calculated based on the ON period and a time period from when the first transistor is turned off until when the inductor current reaches the first predetermined value.

14. A power supply circuit configured to generate an output voltage at a target level from an alternating current (AC) voltage inputted thereto, the power supply circuit comprising:
an inductor configured to receive a voltage corresponding to the AC voltage;
a first transistor configured to control an inductor current flowing through the inductor;
a second transistor connected to the inductor and the first transistor; and
a switching control circuit configured to control switching of the first and second transistors, the switching control circuit including:
a first driver circuit configured to
turn on the first transistor after the inductor current reaches a first predetermined value, and
turn off the first transistor in response to an ON period corresponding to the output voltage having elapsed; and
a second driver circuit configured to,
in response to the ON period of the first transistor being shorter than a fist time period, drive the first transistor in a first mode, the first mode being a mode in which the first transistor is switched in a state where the second transistor is kept off, and
in response to the ON period of the first transistor exceeding the first time period, drive the second transistor in a second mode, the second mode being a mode in which the second transistor is switched complementarily to the first transistor.

15. A power supply circuit configured to generate an output voltage at a target level from an alternating current (AC) voltage inputted thereto, the power supply circuit comprising:
an inductor configured to receive a voltage corresponding to the AC voltage;
a first transistor configured to control an inductor current flowing through the inductor;
a second transistor connected to the inductor and the first transistor; and
a switching control circuit configured to control switching of the first and second transistors, the switching control circuit including:
a first driver circuit configured to
turn on the first transistor after the inductor current reaches a first predetermined value, and
turn off the first transistor in response to an ON period corresponding to the output voltage having elapsed; and
a second driver circuit configured to
drive the second transistor in a first synchronous rectification mode, in response to an instantaneous value of a full-wave rectified voltage dropping below a predetermined level corresponding to the output voltage, the full-wave rectified voltage being obtained by full-wave rectifying the AC voltage, and
drive the second transistor in a second synchronous rectification mode, in response to the instantaneous value exceeding the predetermined level, wherein
the first synchronous rectification mode is a mode in which the second transistor is switched complementarily to the first transistor, and
the second synchronous rectification mode is a mode in which
the second transistor is turned on after the first transistor is turned off, and
the second transistor is turned off, in response to a predetermined time period having elapsed since the inductor current flows in a direction that is opposite to a direction in which the inductor current flows when the first transistor is on.

16. A power supply circuit configured to generate an output voltage at a target level from an alternating current (AC) voltage inputted thereto, the power supply circuit comprising:
an inductor configured to receive a voltage corresponding to the AC voltage;
a first transistor configured to control an inductor current flowing through the inductor;
a second transistor connected to the inductor and the first transistor; and
a switching control circuit configured to control switching of the first and second transistors, the switching control circuit including:
a first driver circuit configured to
turn on the first transistor after the inductor current reaches a first predetermined value, and
turn off the first transistor in response to an ON period corresponding to the output voltage having elapsed; and
a second driver circuit configured to
turn on the second transistor after the first transistor is turned off, and
turn off the second transistor, in response to a predetermined time period having elapsed since the inductor current flows in a direction that is opposite to a direction in which the inductor current flows when the first transistor is on, wherein
the predetermined time period is calculated based on the ON period and a time period from when the first transistor is turned off until when the inductor current reaches the first predetermined value.
